(19) United States
(12) Patent Application Publication
(10) Pub. No.: US 2013/0299428 A1
(43) Pub. Date: Nov. 14, 2013

(54) ANTIMICROBIAL MEMBRANE CONTAINING SILVER NANOPARTICLES

(71) Applicants: Matias Bikel, Delft (NL); Joost Van Erkel, Delft (NL)

(72) Inventors: Matias Bikel, Delft (NL); Joost Van Erkel, Delft (NL)

(73) Assignee: NEDERLANDSE ORGANISATIE VOOR TOEGEPAST- NATUURWETENSCHAPPELIJK ONDERZOEK TNO, DELFT (NL)

(21) Appl. No.: 13/822,808

(22) PCT Filed: Sep. 13, 2011
(86) PCT No.: PCT/NL11/50622

§ 371 Date: May 24, 2013

(30) Foreign Application Priority Data
Sep. 13, 2010 (EP) 10176338.1

(51) Int. Cl. B01D 69/14; C02F 1/44

(52) U.S. Cl. CPC B01D 69/141; C02F 1/44
USPC 210/650; 210/500.25; 427/244; 427/553

(57) ABSTRACT

The invention is directed to an antimicrobial membrane, to a method for preparing said antimicrobial membrane, to a process of operating said antimicrobial membrane, and to uses of said antimicrobial membrane.

The antimicrobial membrane of the invention comprises on at least one side of the membrane a multilayer coating, said multilayer coating having alternate polycation and polyanion layers, wherein one or more polycation layers and one or more polyanion layers comprise metal nanoparticles having antimicrobial activity, wherein
i) said metal nanoparticles comprise silver; and
ii) at least 75 wt. % of said metal is present in a reduced form.

The invention is directed to an antimicrobial membrane, to a method for preparing said antimicrobial membrane, to a process of operating said antimicrobial membrane, and to uses of said antimicrobial membrane.

Membrane modification is a convenient method of modifying and tuning the surface of membranes with desired properties. Depending on the application in which the membrane is to be used, many different properties may be desirable.

A particular problem often observed in water treatment membrane processes is biofouling. Many attempts have been made to overcome the problem of biofouling including feed water pre-treatment, membrane surface modification, module hydrodynamic improvements, process optimisation, and chemical cleaning So far, these attempts have not provided a satisfactory result. Accordingly, there is a strong need in membrane technology for overcoming the costly problem of biofouling.

An important cause for biofouling is adherence of microorganisms to the membrane and their proliferation. Membranes having antimicrobial properties have improved rejection to microorganisms and accordingly are subject to less biofouling. In turn, this leads to better performance and prolonged operation of the membrane. In addition, the antimicrobial properties of the membrane allow the disinfection of fluid which is in contact with the membrane, in particular water.

In the art, some efforts have been made in overcoming biofouling problems by introducing antimicrobial properties.

For example, some systems rely on the contact between water and highly porous carbon doped with silver before filtering the water with a membrane. The membrane itself, however, is still susceptible to biofouling, since the water and the silver in these systems have a relatively short contact time. Microorganisms that survive the silver activated carbon pre-treatment may give rise to proliferation on the membrane surface, leading to biofilm formation and pore clogging. In addition, the unprotected silver particles may dissolve far too quickly to make the system durable.

It is also known to provide a silver layer either on the encasement of the membrane module or a silver liquid outlet. However, for these systems it is almost impossible that all the water that passes the system is treated. The treatment offered by these devices is limited to the contact surface of the water with the encasement or the water outlet. Further, the residence times are very short, which as mentioned above may lead to unsatisfactory killing of microorganisms.

KR-A-2007/0 071 832 describes a membrane impregnated with silver nanoparticles. A flat membrane is prepared by a phase inversion process involving preparing a polymer solution and adding silver nitrate to the polymer solution, and manufacturing a flat membrane from the mixed solution by a phase inversion process. Afterwards, the membrane is brought into contact with silver nanoparticles. These silver nanoparticles are unprotected and can, therefore, dissolve extremely quickly.

US-A-2003/0 215 626 discloses a coating of polyelectrolyte multilayers with titanium dioxide nanoparticles. These nanoparticles are only active when exposed to ultraviolet radiation, which is disadvantageous in a membrane module, especially with high packing density. Furthermore, polyelectrolytes are degraded by titanium dioxide oxidation, which decreases long term stability of the system.

US-A-2004/0 249 469 describes a coating of polyelectrolyte multilayers and mentions that silver can be incorporated into the layers. This document does not disclose that the silver is incorporated in both the polycation and the polyanion layers. In addition, this document is silent as regards the oxidation state of the silver.

Malaisamy et al. presented at the 19^{th} annual meeting of the North American Membrane Society in 2009 in Charleston, S.C., USA a polyethersulphone membrane that is modified by layer-by-layer polyelectrolyte deposition. The polyanion used is polystyrenesulphonate. The polycation used is poly(diallyldimethylammonium chloride). This polycation cannot hold silver. Silver is only present as an ion in the polyanion layers.

There remains a strong need in the art for further antimicrobial membranes that are capable of effectively reducing the amount of biofouling in water treatment membrane processes. Objective of the present invention is to fulfill this need present in the art.

The inventors found that this objective can be met by modifying a membrane using a layer by layer technique.

Accordingly, in a first aspect the invention is directed to an antimicrobial membrane, comprising on at least one side of the membrane a multilayer coating, said multilayer coating having alternate polycation and polyanion layers, wherein one or more polycation layers and one or more polyanion layers comprise metal nanoparticles having antimicrobial activity, wherein
i) said metal nanoparticles comprise silver; and
ii) at least 75 wt. % of said metal is present in a reduced form.

The nanoparticles in the multilayer coating of the membrane of the invention are protected by the polyanion and polycation layers, leading to longer dissolution times. Further, since microorganisms are retained by the active surface of the membrane, where the antimicrobial nanoparticles are located, a satisfactory degree of microorganism killing is achieved. In addition, since the metal nanoparticles are present in one or more polyanion as well as one or more polycation layers, the overall loading of metal nanoparticles can effectively be higher than a system wherein metal nanoparticles are present in either one of the polyanion or polycation layers. As a result, the antimicrobial membrane of the invention has improved antimicrobial activity.

Any commercially available membrane having some surface charge may be used in accordance with the invention. The membrane can have a positive or negative surface charge. The membrane can suitably be an ultrafiltration or a microfiltration membrane. Furthermore, the membrane may be a hydrophilic membrane or a hydrophobic membrane. It is preferred that the membrane be a hydrophilic membrane, because it is known that the hydrophilic character of the membrane improves the resistance against microorganism adherence, and accordingly against biofouling. In addition, the presence of the multilayer coating increases the hydrophilicity of the membrane. Furthermore, in accordance with the invention polymeric membranes are preferred. Good results have, for example, been obtained using a polyethersulphone membrane. Other membrane materials that are particularly suitable for the invention include polyamines, polyamides, polyethers, polyesters, etc.

The terms “polycation” and “polyanion” as used in this application relate to the commonly used broader term “polyion”, which commonly refers to a molecule consisting of a plurality of charged groups that are linked to a common backbone. The term “polyion” should not be mistaken with the term “polyvalent ion”, which commonly refers to an ion with a charge higher than +1 (or lower than −1). Hence, in the context of this application it is clear that the term “polycation” is interchangeable with the term “positively charged polyelectrolyte” and that the term “polyanion” is interchangeable with the term “negatively charged polyelectrolyte”.

The one or more polycation layers and the one or more polyanion layers preferably comprise the same type of metal nanoparticles. Preferably, the metal nanoparticles in the one or more polycation layers and the one or more polyanion layers are identical.

The metal nanoparticles used in the multilayer coating of the antimicrobial membrane of the invention have antimicrobial activity. The term “antimicrobial activity” as used in this application is meant to refer to the ability to inhibit the growth of or actually kill microorganisms. Preferably, the nanoparticles have antibacterial activity, which means that the antimicrobial activity is directed against one or more bacteria.

It is preferred that each layer in the multilayer coating of the antimicrobial membrane of the invention has antimicrobial activity, more preferably each layer of the multilayer coating of the antimicrobial membrane comprises the metal nanoparticles. Antimicrobial activity in the multilayer coating may have its origin in the metal nanoparticles, but in addition in the nature of the polyanion and/or polycation used.

The metal nanoparticles in the antimicrobial membrane of the invention comprise silver. In particular, silver nanoparticles are suitable as the metal nanoparticles that have antimicrobial activity. It is further possible to use a blend of more than one type of metal nanoparticle. The metal nanoparticles in accordance with the invention are preferably complexed by the polyanion and polycation. As a result, the metal nanoparticles can be present both in the negatively and in the positively charged layers, which increases the overall possible loading of metal nanoparticles in the multilayer coating while decreasing the total number of layers (as each layer contributes to decreasing the permeability of the membrane, see Kochan et al., Desalination 2010, 250, 1008-1010). The inventors found that this increased overall loading gives rise to much more effective antimicrobial properties. In addition, no exposure to ultraviolet radiation is required during operation of the membrane.

The metal nanoparticles can have an average particle size as measured by SEM in the range of 1-1000 nm, preferably in the range of 1-400 nm. The particle size distribution as determined by SEM is preferably such that at least 90% of the particles have a particle size in the range of 1-200 nm.

The alternate polyanion and polycation layers have advantageous electrostatic attractions. In case of a negatively charged membrane surface, the layer closest to the membrane will usually be a polycation layer. In case of a positively charged membrane surface, the layer closest to the membrane will usually be a polyanion layer.

For each polyanion layer it is possible to use the same type of polyanion, and for each polycation layer it is possible to use the same type of polycation. However, it is also possible to apply different types of polyanions in different polyanion layers and/or to apply different types of polycations in different polycation layers.

Various types of polycations and polyanions are available. It is preferred that the polycations and polyanions be polyelectrolytes, i.e. polymers that dissociate in aqueous solutions and as a result become charged.

Examples of suitable polycations include chitosan (and derivatives thereof), polyamines, and poly di-allyl di-methyl ammonium salts. It is preferred that the polycation comprises chitosan (or a derivative thereof), since chitosan possesses antimicrobial activity (more in particular antibacterial activity).

Examples of suitable polyanions include poly(methacrylic acid), polystyrene sulphonate salts, and polyphenols. In particular, when the nanoparticles comprise silver, it is preferred that the polyanion comprises poly(methacrylic acid), since poly(methacrylic acid) can effectively reduce metals and protect metallic nanoparticles. This also applies to poly(methyl methacrylate), poly(methyl acrylate-co-methacrylic acid, and polydiallyl dimethyl ammonium chloride (PDADMAC). Therefore, the polyanion may also comprise one or both of these compounds.

The polycation can suitably have a molecular weight of at least 300 g/mol, such as in the range of 300-50 000 g/mol. Similarly, the polyanion can suitably have a molecular weight of at least 300 g/mol, such as in the range of 300-50 000 g/mol.

The multilayer coating of the antimicrobial membrane of the invention may have any number of layers. Each layer improves the performance of the membrane in terms of rejection of solutes and antimicrobial activity (preferably antibacterial activity in terms of dead bacteria), but on the other hand decreases the permeability of the membrane (Kochan et al., Desalination 2010, 250, 1008-1010). Accordingly, an optimum has to be found depending on the intended application. Normally, the multilayer coating will have a thickness in the range of 0-5 μm, preferably 0-2 μm. The multilayer coating preferably consists of 1-20 layers, more preferably 2-6 layers, such as 2-4 layers. Each polyanion layer typically has a thickness in the range of 0-200 nm. Each polycation layer typically has a thickness in the range of 0-200 nm. Because the invention allows a relatively high loading of metal nanoparticles (due to their presence in both polycation and polyanion layers), the number of layers can be relatively small. Hence, the antimicrobial membrane of the invention is able to maintain a relatively high permeability of the membrane while introducing effective antimicrobial activity.

In a preferred embodiment, 95 wt. % of the metal in the metal nanoparticles is present in reduced form. More preferably, at least 98 wt. % of said metal is present in a reduced form, and even more preferably substantially all of said metal is present in a reduced form.

The reduced form of the metal corresponds to an oxidation state of zero. For example, in the case of silver nanoparticles, 75 wt. % of the silver is present in its reduced Ag⁰ state, preferably 95 wt % of the silver is present in its reduced Ag⁰ state, more preferably 98 wt. % of the silver is present in its reduced Ag⁰ state, and even more preferably substantially all of the silver is present in its reduced Ag⁰ state. Advantageously, when such a large amount (and preferably all) of the metal is present in reduced form, i.e. with an oxidation state of zero, the metal can be applied in both the polycation as well as the polyanion layer. If the metal is, for example, provided as a cation, this typically leads to coiling of the polyanion due to charge neutralisation (compensation). This in turn can give rise to decreased permeability. Another disadvantage of using a charged metal is that the metal dissolves more quickly and there is lower attraction between the polyanion and polycation layers (because in this example the total charge of the polyanion is effectively decreased).

According to a preferred embodiment of the invention, the polycation layer comprises chitosan loaded with silver nanoparticles. The synthesis of chitosan-based silver nanoparticles is, for instance, described by Wei et al. (Carbohydrate Research 2009, 344, 2375-2382). This polycation layer can, for instance, be used as the first layer on a polyethersulphone membrane. In accordance with this preferred embodiment, the polyanion layer which is applied on top of this layer comprising chitosan loaded with silver nanoparticles, is a poly(methacrylic acid) loaded with silver nanoparticles. The synthesis of poly(methacrylic acid)-based silver nanoparticles is, for instance, described by Dubas et al. (Colloids and Surfaces A: Physicochem. Eng. Aspects 2006, 289, 105-109). Alternatively, the polyanion layer can be a layer of poly(methyl methacrylate) loaded with silver nanoparticles, a layer of poly(methyl acrylate-co-methacrylic acid) loaded with silver nanoparticles, or a layer of polydiallyl dimethyl ammonium chloride loaded with silver nanoparticles. Naturally, also polyanion layers having combinations of these polymers loaded with silver nanoparticles are possible.

In a further aspect, the invention is directed to a method for preparing the antimicrobial membrane of the invention, comprising
providing a membrane; and
coating at least one side of said membrane alternately with polyanion layers and polycation layers, wherein one or more of said polyanion layers and one or more of said polycation layers comprise metal nanoparticles having antimicrobial activity, and wherein
i) said metal nanoparticles comprise silver; and
ii) at least 75 wt. % of said metal is present in a reduced form.

In a preferred embodiment of the method of the invention, at least 95 wt % of the metal is present in reduced form.

Alternately coating the membrane with polyanion and polycation layers can be achieved, for instance, by a layer-by-layer deposition technique (also known as polyelectrolyte multilayers or PEM) (Decher, Science 1997, 277, 1232-1237). In accordance with this technique polyelectrolyte films can be assembled by successive dipping of a substrate in dilute solutions of oppositely charged polyelectrolytes followed by a rinse in water. The immobilisation of the polyelectrolytes occurs via electrostatic and/or hydrophobic interactions and results in a film which thickness and properties can be finely tuned. Organic and/or inorganic molecules can also be deposited to bring further properties to the resulting film and/or to the membrane. For instance, it is possible to reduce the molecular weight cut-off of a membrane by more than 50% (from 150 kDa to less than 75 kDa) by depositing organic and/or inorganic molecules. As a result, an ultrafiltration membrane can for example be converted into a nanofiltration membrane.

The metal nanoparticles can suitably be synthesised in solution. The nanoparticles can then be added to the polyelectrolyte solutions, after which the polyanion and polycation layers are alternately coated on the membrane, for instance by a layer-by-layer deposition technique. This is advantageous because it allows a simple of preparation of the antimicrobial membrane of the invention, as opposed to intricate prior art methods wherein a metal is introduced after the multilayer has been coated. Hence, in a preferred embodiment, the polyanion layers and polycation layers are coated from polyelectrolyte solutions which polyelectrolyte solutions comprise the metal nanoparticles.

It is advantageous to perform a further step of reducing metal after having coated the polyanion and polycation layers in order to increase the amount of metal in reduced form (oxidation state of zero) and improve cross-linking among the different layers. This further step may be used to reduce any metal that may still be present in ionic form. Also, metal that is oxidised during preparation can in this way be reduced to the metallic form. This step can also be used to induce cross-linking within the multilayer coating. Ways of achieving this include, for instance, exposing the coated membrane to ultraviolet radiation and/or exposing the coated membrane to hot water.

In a further aspect, the invention is directed to a process of operating an antimicrobial membrane according to the invention in a membrane module, comprising controlling release of the metal from the antimicrobial membrane.

For some applications it may be desirable to have, to a certain extent, control on the release of the metal from the antimicrobial membrane of the invention. This would allow some regulation over the metal dissolution rate. This can be achieved by the use of one or more reducing agents (such as biomagnetite). Biomagnetite refers to magnetite that is synthesised by microorganisms and has a stronger activity than magnetite. It is a reducing agent which can control the release of metal nanoparticles (such as silver) by not allowing to become oxidised. Biomagnetite can, for example, be added as an anion on top of a last polycation layer of the membrane of the invention. Experiments showed that the release of metal nanoparticles was kept at about 50% of that of the same membrane without biomagnetite. If some metal is released by oxidation and not absorbed by bacteria, the reducing agent can be used to re-reduce the released metal. Another possibility is to apply a potential difference between the membrane surface and the encasement of, for instance, a membrane module. This would be especially applicable when electrically conducting polymers are used. By applying a cathodic bias on the membrane, for example, the tendency towards oxidation of metal nanoparticles can be curbed. This is because the cathode would supply the oxidised metal with electrons, leading to reduction and redeposition. The anode can, for instance, be (connected to) the housing of the module.

In yet a further aspect, the invention is directed to the use of the antimicrobial membrane of the invention for disinfecting a retentate and/or a permeate. Depending on which side(s) of the membrane the multilayer coating is applied (retentate side, permeate side, or both) the membrane can be used for disinfecting a retentate or permeate. The antimicrobial membranes of the invention are highly suitable for this purpose, because they have a relatively high loading of metal nanoparticles which is comprised in one or more polyanion and one or more polycation layers. A controllable release of the metal as described above can be applied to increase the effect.

In yet a further aspect, the invention is directed to the use of the antimicrobial membrane of the invention in a water treatment. The water treatment can for instance be a surface water treatment for the preparation of drinking water. In such a treatment the antimicrobial membrane of the invention may be used for disinfecting the surface water.

The invention described in this patent application is the result of the NAMETECH project, co-funded by the European Commission within the Seventh Framework Programme Contract No. 226791.

The invention will now be illustrated by means of the following Examples.

### EXAMPLES

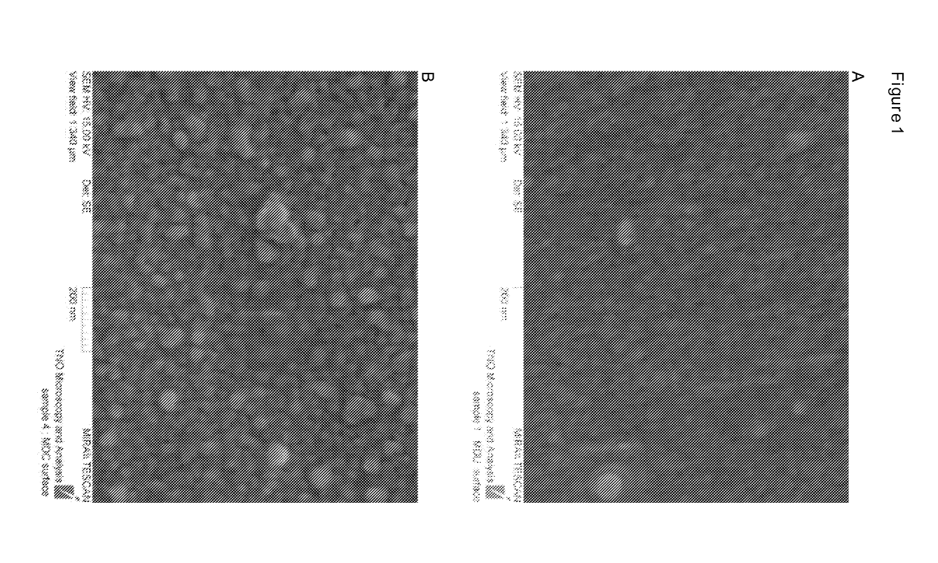

In the following examples, three membranes were compared:
A) The untreated base membrane (Microdyn-Nadir, UP150), FIG. 1-A, scanning electronic microscope image. Membrane A.
B) Membrane A, treated with a scheme of polycation-polyanion-polycation including silver nanoparticles, according to the references cited in the text (Dubai, Wei): Chitosan+Ag⁰, poly(methacrylic acid)+Ag⁰, chitosan+Ag⁰. Each layer was applied through dipping in the each polyelectrolyte solution for five minutes, followed by a rinse in water, under stirring for five minutes. After the three layers were applied, the membrane was exposed to UV light for 10 minutes. FIG. 1-B, scanning electronic microscope image. Silver loading was determined through WDXRF (wavelength dispersive X-ray fluorescence) and found to be around 0.1 g/cm². Membrane B, according to the invention.
C) Membrane A treated with a six layer scheme, polycation, polyanion, polycation, polyanion, polycation, polyanion. Silver was introduced in the polyanion layers in the form of Ag⁺. The polycation in use was poly(diallyl dimethyl ammonium) and the polyanion in use was poly(styrene sulphonate). Each layer was applied through dipping in the polyelectrolyte solutions for 20 minutes and rinsing in water for one hour. Membrane C.

To measure antibacterial activity, two different methods were used. In the first one, a fixed amount of bacteria was set on three different membranes and allowed to stand for thirty minutes (exposure). Afterwards, said membranes were printed off onto agar plates (transferral of bacteria from the membrane to the agar) and incubated at 37° C. overnight (to detect viable bacteria, not killed during the exposure time). Upon analysis, an untreated polyethersulphone membrane (Membrane A) yielded 30 colony forming units (CFU) per square centimetre (seeded value: 40 CFU per square centimetre, 25% reduction). Membrane C presented around 10 colony forming units per square centimetre (75% reduction). No colony forming units were detected on the agar plate corresponding to Membrane B. In this case, the amount of bacteria in use was too low to find the limit of the method.

In the second test, the ability of the membranes to inhibit bacterial growth was measured through determinations of the lag time of bacterial growth in a broth containing a piece of the tested membrane with bacteria deposited on its surface. It was observed that for Membranes A and C, the inhibition time is about 3 hours. For the antimicrobial membrane of the invention, (Membrane B) the inhibition time was increased to 14 hours. It must be indicated that the bacterial concentration used in this experiment was exaggeratedly high, to allow for respirometric measurements.

1. Antimicrobial membrane, comprising on at least one side of the membrane a multilayer coating, said multilayer coating having alternate polycation and polyanion layers, wherein one or more polycation layers and one or more polyanion layers comprise metal nanoparticles having antimicrobial activity, wherein
i) said metal nanoparticles comprise silver; and
ii) at least 75 wt. % of said metal is present in a reduced form.

2. Antimicrobial membrane according to claim 1, wherein the one or more polycation layers and the one or more polyanion layers comprise the same type of metal nanoparticles.

3. Antimicrobial membrane according to claim 1, wherein each layer of said multilayer coating has antimicrobial activity, preferably each layer of said multilayer comprises metal nanoparticles having antimicrobial activity.

4. Antimicrobial membrane according to claim 1, wherein said metal nanoparticles are silver nanoparticles.

5. Antimicrobial membrane according to claim 1, wherein at least one of said polycation layers comprises chitosan.

6. Antimicrobial membrane according to claim 1, wherein at least one of said polyanion layers comprises poly(methacrylic acid) and/or poly(methyl methacrylic acid).

7. Antimicrobial membrane according to claim 1, wherein the multilayer coating has a total thickness less than 5 μm, preferably less than 2 μm, and preferably consists of 2-6 layers.

8. Antimicrobial membrane according to claim 1, wherein said metal nanoparticles have an average particle size as measured by SEM in the range of less than 1000 nm, preferably less than 200 nm.

9. Antimicrobial membrane according to claim 1, wherein at least 95 wt. % of said metal is present in a reduced form, preferably at least 98 wt. % of said metal is present in a reduced form, more preferably substantially all of said metal is present in a reduced form.

10. Antimicrobial membrane according to claim 1, wherein the membrane has a negative surface charge and is preferably selected from the group consisting of a polyethersulphone membrane, a polyamide, and a polyester.

11. Method for preparing an antimicrobial membrane according to claim 1, comprising
providing a membrane; and
coating at least one side of said membrane alternately with polyanion layers and polycation layers, wherein one or more of said polyanion layers and one or more of said polycation layers comprise metal nanoparticles having antimicrobial activity, and wherein
i) said metal nanoparticles comprise silver; and
ii) at least 75 wt. % of said metal is present in a reduced form.

12. Method according to claim 11, said method further comprising reducing said metal nanoparticles, preferably by exposing the coated membrane to ultraviolet radiation or to hot water.

13. Method of operating an antimicrobial membrane as defined in claim 1 in a membrane module, comprising controlling release of the metal from the antimicrobial membrane, for example by application of a potential difference between the membrane surface and an encasement for said membrane or by adding one or more reducing compounds, such as biomagnetite.

14. Use of an antimicrobial membrane according to claim 1 for disinfecting a retentate and/or a permeate.

15. Use of an antimicrobial membrane according to claim 1 in a water treatment, preferably for disinfecting surface water.

16. Method of operating an antimicrobial membrane obtainable by a method according to claim 11 in a membrane module, comprising controlling release of the metal from the antimicrobial membrane, for example by application of a potential difference between the membrane surface and an encasement for said membrane or by adding one or more reducing compounds, such as biomagnetite.

17. Use of an antimicrobial membrane obtainable by a method according to claim 11 for disinfecting a retentate and/or a permeate.

18. Use of an antimicrobial membrane obtainable by a method according to claim 11 in a water treatment, preferably for disinfecting surface water.
